(19) United States
(12) Patent Application Publication
(10) Pub. No.: US 2025/0296208 A1
(43) Pub. Date: Sep. 25, 2025

(54) TOOL WITH ADJUSTABLE CONFIGURATIONS

(71) Applicant: Hong Ann Tool Industries Co., Ltd., Taichung City (TW)

(72) Inventor: Cheng-Wei SU, Taichung City (TW)

(21) Appl. No.: 19/007,344

(22) Filed: Dec. 31, 2024

(30) Foreign Application Priority Data
Mar. 21, 2024 (TW) 113110598

(51) Int. Cl. B25B 23/00; B25G 1/06

(52) U.S. Cl. CPC B25B 23/0028; B25G 1/063

(57) ABSTRACT

A tool with adjustable configurations comprises a handle, an element, and a transformation mechanism. The handle extends along a first reference axis. The element extends along a second reference axis and includes a non-circular engagement hole. The transformation mechanism comprises a first slide seat with a first slide groove having first and second engaging portions, and a toggle button simultaneously engaged with the engagement hole and first slide groove. The toggle button has a third engaging portion that maintains engagement with the engagement hole while being switchable between multiple positions including: a transformation position allowing element rotation, a first fixed position maintaining the second reference axis parallel to the first reference axis, and a second fixed position maintaining the second reference axis perpendicular to the first reference axis.

### BACKGROUND OF THE INVENTION

The present invention relates to hand tools, and more particularly, to a hand tool that is adjustable to multiple configurable positions, providing enhanced flexibility and adaptability for a variety of tasks.

U.S. Patent No. U.S. Pat. No. 7,047,846 B1 discloses a hand tool that includes a compartment with a through-hole in the handle. A latching unit is inserted into this through-hole, with one end of the unit featuring a latching block. Inside the compartment, a fixed seat is secured, and this seat has a push rod that engages with the latching unit. The opposite end of the bent handle includes a gear, and the peripheral edge of the gear has a groove where the latching block of the latching unit can engage.

However, this hand tool requires the operator to rotate the fixed seat to adjust the handle's position, which is a slow and cumbersome process. The operator must first loosen the fixed seat, adjust the bent handle to the desired angle, and then tighten the fixed seat again to engage the latching block. This design does not meet the needs for quick and efficient operation. Additionally, when excessive force is applied, the engagement between the teeth and grooves may slip, compromising the position-locking effect. The design also limits the handle configurations to primarily straight and 90-degree angles, which may not be practical for all applications.

Hand tools, particularly wrenches and similar implements, are frequently used in confined spaces requiring different angular positions. While adjustable tools exist in the prior art, such as those disclosed in U.S. U.S. Pat. No. 7,047,846 B1, conventional designs typically employ complex adjustment mechanisms that are cumbersome to operate and may not maintain stable positioning during high-torque applications. Furthermore, existing solutions often limit users to straight or 90-degree configurations, thereby reducing their effectiveness in various working environments.

The present invention is, therefore, intended to obviate or at least alleviate the problems encountered in the prior art.

### SUMMARY OF THE INVENTION

The invention is a tool comprising a handle, an element, and a transformation mechanism. The handle extends along a first reference axis and has a first end and an opposing second end. The element extends along a second reference axis. The element has a non-circular engagement hole at a first end inserted into the handle. The transformation mechanism comprises a first slide seat and a toggle button. The first slide seat is disposed within the handle and includes a first slide groove. The first slide groove has a first engaging portion at one end and a second engaging portion at another end. The first engaging portion is positioned near the first end, while the second engaging portion is located between the first and second ends. The toggle button is simultaneously inserted into both the engagement hole and the first slide groove. The toggle button has a third engaging portion on an outer periphery thereof that remains engaged within the engagement hole, ensuring synchronized rotation between the toggle button and the element.

The toggle button can be switched between a transformation position where the third engaging portion disengages from the first slide groove, allowing the element to rotate relative to the handle; a first fixed position where the third engaging portion engages with the first engaging portion, preventing element rotation; and a second fixed position where the third engaging portion engages with the second engaging portion, preventing element rotation.

Thus, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new features of the invention will become apparent from the following detailed description of the invention when considered in conjunction with the accompanied drawings.

### BRIEF DESCRIPTION OF DRAWINGS

FIG. 1 is a perspective view of a tool with adjustable configurations in accordance with the present invention.

FIG. 2 is an exploded perspective view of the tool with adjustable configurations of FIG. 1.

FIG. 3 is another exploded perspective view of the tool with adjustable configurations of FIG. 1 from a different angle.

FIG. 4 is a cross-sectional view showing the internal structure of a transformation mechanism of the tool with adjustable configurations of FIG. 1.

FIG. 5 is a cross-sectional view showing a toggle button of the tool with adjustable configurations of FIG. 1 in the first fixed position.

FIG. 6 is a cross-sectional view showing the toggle button in the transformation position.

FIG. 7 is a cross-sectional view showing the toggle button in the third fixed position.

FIG. 8 is a cross-sectional view showing the toggle button in the fourth fixed position.

FIG. 9 is a cross-sectional view showing the toggle button in the second fixed position.

### DETAILED DESCRIPTION OF THE INVENTION

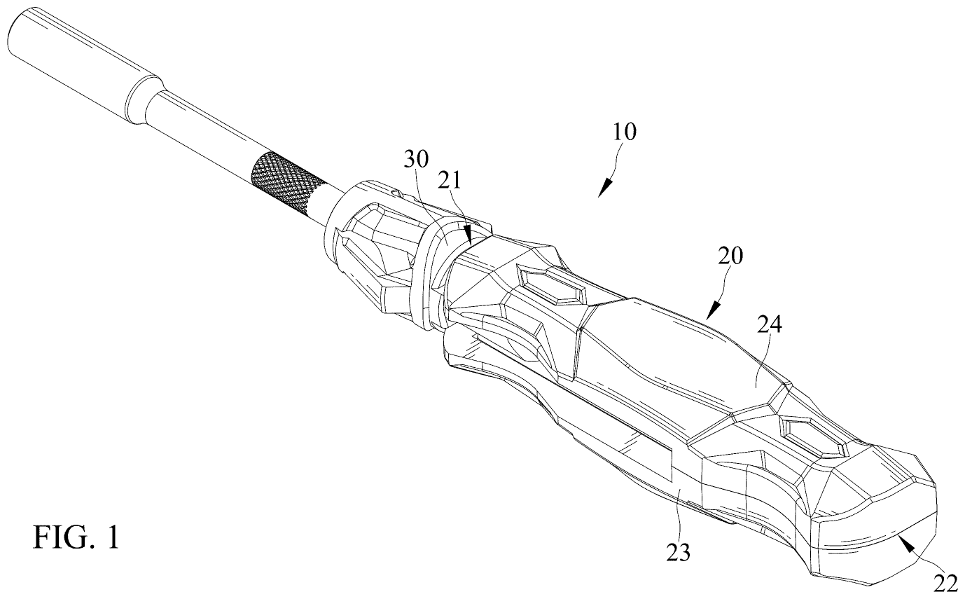

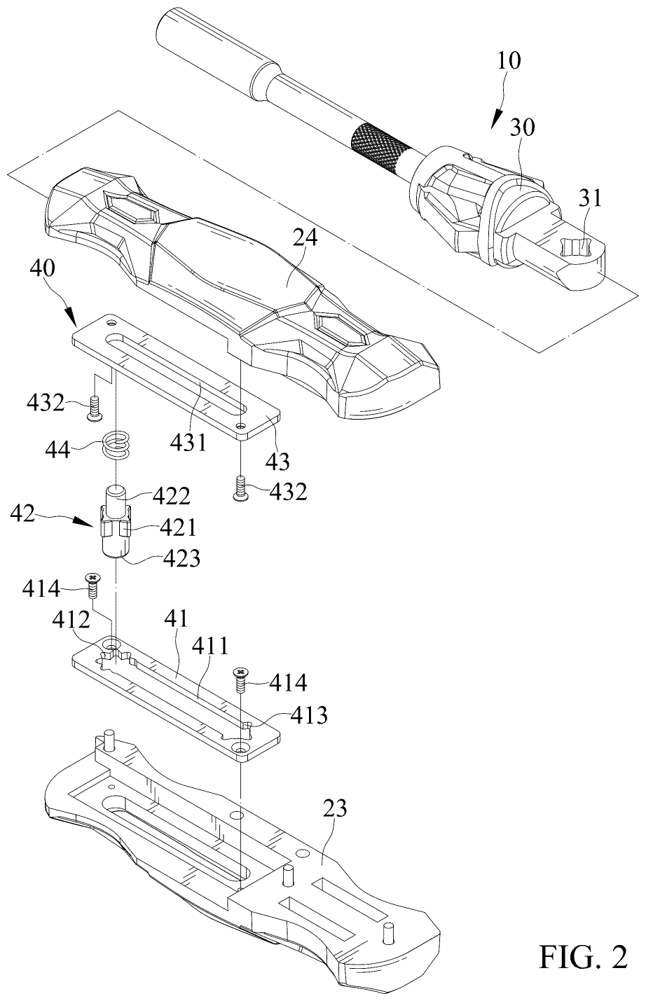

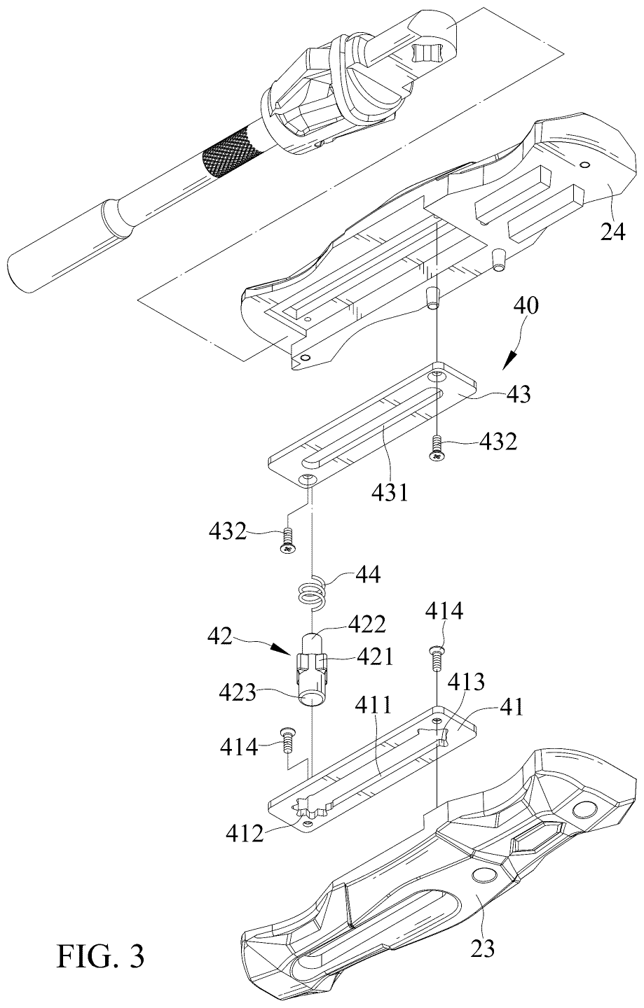

Referring to FIGS. 1-9, a tool 10 in accordance with the present invention comprises a handle 20, an element 30, and a transformation mechanism 40.

The handle 20 extends along a first reference axis L1 and has a first end 21 and an opposing second end 22.

The element 30 extends along a second reference axis L2. The element 30 includes a non-circular engagement hole 31 at one end that is inserted into the handle 20. The element 30 has a working end. The working end protrudes from the handle 20.

The transformation mechanism 40 comprises a first slide seat 41 and a toggle button 42. The first slide seat 41 is disposed within the handle 20 and includes a first slide groove 411. The first slide groove 411 has a first engaging portion 412 at one end and a second engaging portion 413 at another end. The first engaging portion 412 is positioned near the first end 21, while the second engaging portion 413 is located between the first end 21 and second end 22.

The toggle button 42 is simultaneously inserted into both the engagement hole 31 and the first slide groove 411. The toggle button 42 has a third engaging portion 421 on an outer periphery thereof that remains engaged within the engagement hole 31, ensuring synchronized rotation between the toggle button 42 and the element 30. The third engaging portion 421 is configured to selectively engage with either the first engaging portion 412 or second engaging portion 413 to define specific angular positions.

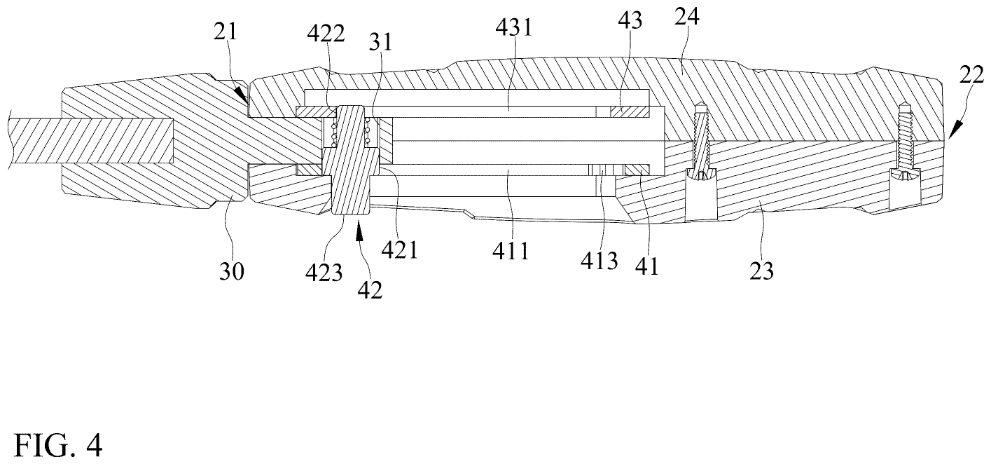

As shown in FIGS. 4-6, the transformation mechanism 40 further comprises a second slide seat 43. The end of the element 30 that is inserted into the handle 20 is positioned between the first slide seat 41 and the second slide seat 43. The second slide seat 43 is disposed within the handle 20 and includes a second slide groove 431 that guides the movement of the toggle button 42.

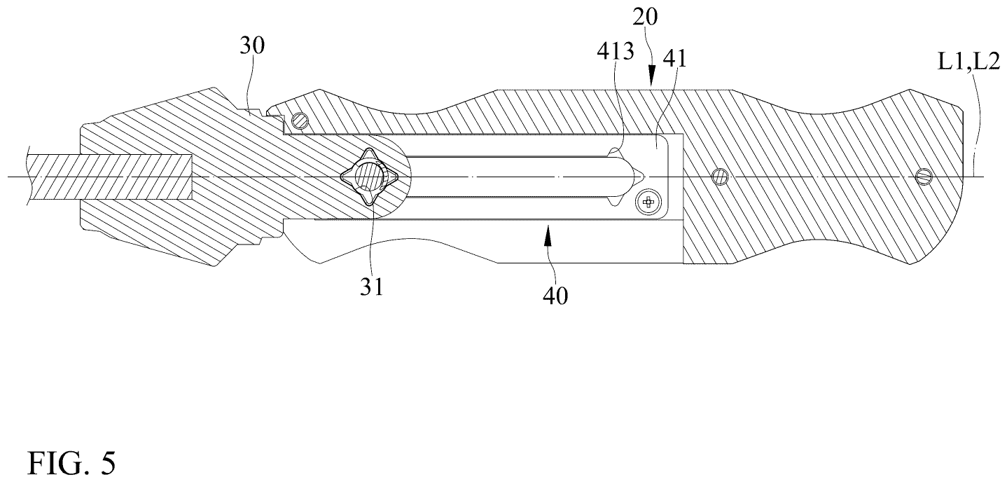

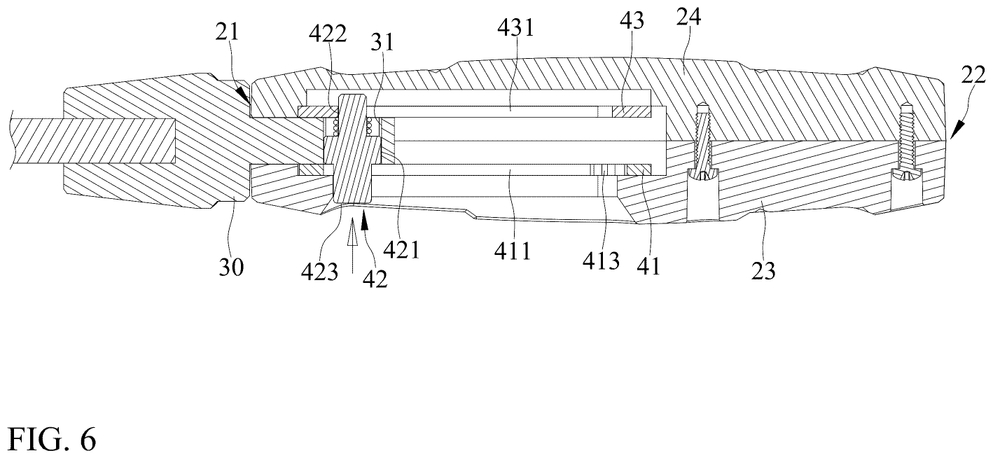

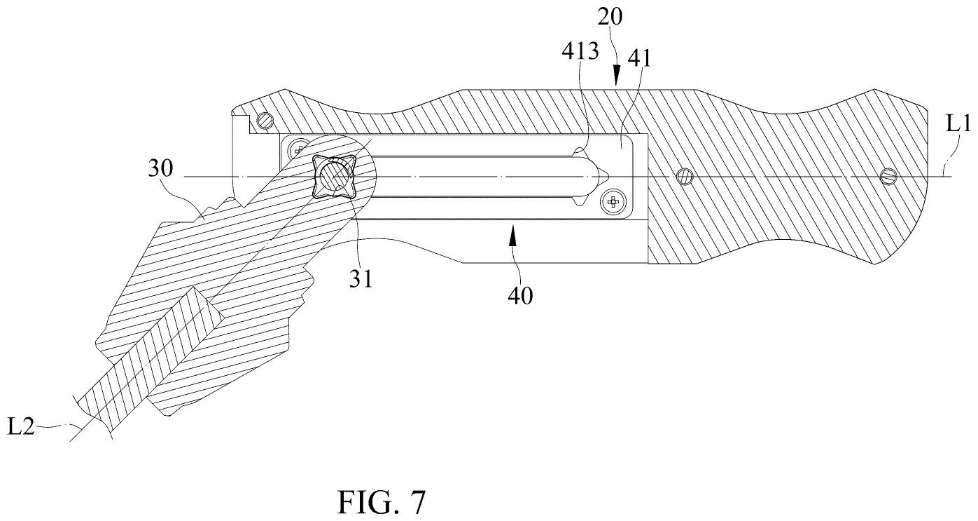

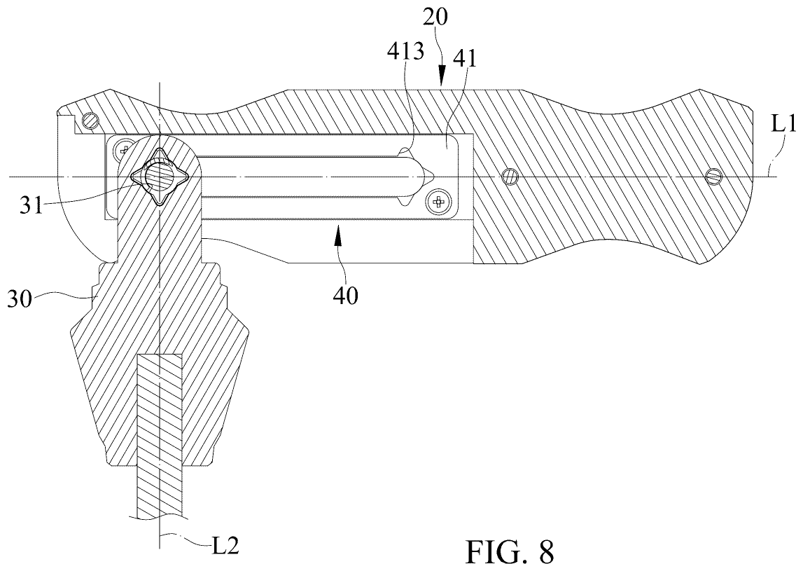

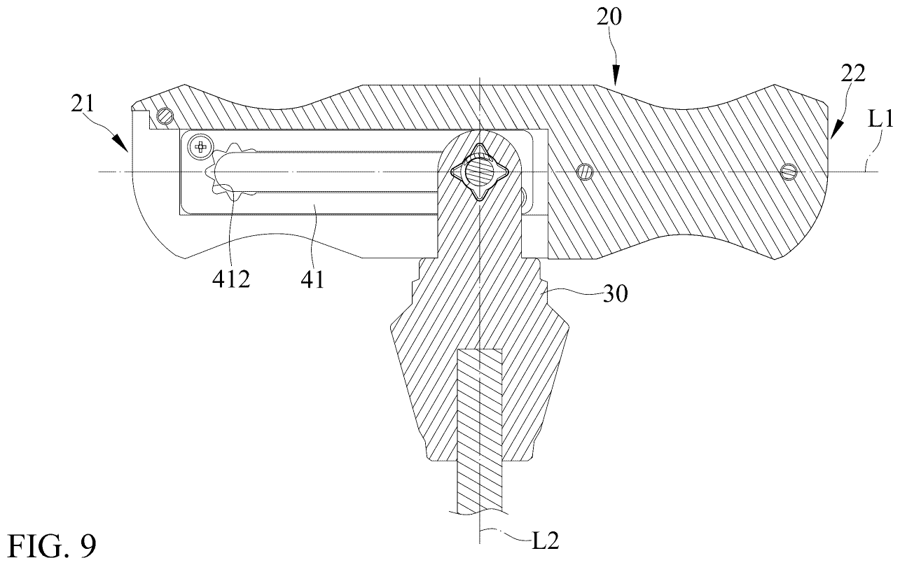

As illustrated in FIGS. 5-9, the toggle button 42 can be positioned in multiple configurations: FIG. 5 shows the first fixed position where the element 30 is parallel to the handle 20 (0 degrees); FIG. 7 shows the third fixed position where the element 30 is at 45 degrees relative to the handle 20, achieved by a specifically shaped third engaging portion 421 that engages with a corresponding recess in the first engaging portion 412; FIG. 8 depicts the fourth fixed position where the element 30 is at 60 degrees relative to the handle 20; FIG. 9 shows the second fixed position where the element 30 is perpendicular (90 degrees) to the handle 20; and FIG. 6 illustrates the transformation position where the third engaging portion 421 is disengaged, allowing free rotation.

The toggle button 42 has a stabilizing portion 422 at one end and a pressing portion 423 at another end. The third engaging portion 421 is positioned between the stabilizing portion 422 and the pressing portion 423. The stabilizing portion 422 is slidably inserted into the second slide groove 431, while the pressing portion 423 protrudes from the handle 20 on the side of the first slide seat 41 opposite from the second slide seat 43, allowing for user actuation.

A spring 44 is mounted on the toggle button 42 between the third engaging portion 421 and the stabilizing portion 422. One end of the spring 44 abuts against the second slide seat 43 while another end abuts against the third engaging portion 421. The spring 44 biases the third engaging portion 421 to engage with either the first engaging portion 412 or the second engaging portion 413.

The first slide seat 41 and second slide seat 43 are both manufactured from metal materials to provide sufficient structural strength.

The handle 20 includes a first handle half 23 and a second handle half 24. The first slide seat 41 connects to multiple first fasteners 414 and is secured to the first handle half 23 by these fasteners 414. Similarly, the second slide seat 43 connects to multiple second fasteners 432 and is secured to the second handle half 24 by these fasteners 432. The second handle half 24 joins with the first handle half 23, positioning the first slide seat 41 and second slide seat 43 in opposition to each other.

In view of the foregoing, the tool 10 can change its configuration to provide users with multiple operating positions. The transformation mechanism 40 constrains the position and angle of the element 30 relative to the handle 20. The metal construction of the first slide seat 41 and second slide seat 43 provides excellent structural strength, preventing transformation or damage even under high torque loads.

Although specific embodiments have been illustrated and described, numerous modifications and variations are still possible without departing from the scope of the invention. The scope of the invention is limited by the accompanying claims.

1. A tool with adjustable configurations comprising:
a handle extending along a first reference axis and having a first end and an opposing second end;
an element extending along a second reference axis, wherein the element has a non-circular engagement hole at a first end thereof inserted into the handle and a second end thereof protruding from the handle; and
a transformation mechanism comprising a first slide seat and a toggle button, wherein the first slide seat is disposed within the handle and includes a first slide groove, wherein the first slide groove has a first engaging portion proximate to the first end and a second engaging portion positioned between the first end and the second end, wherein the toggle button is simultaneously engaged with the engagement hole and the first slide groove, wherein the toggle button has a third engaging portion on an outer periphery thereof configured to maintain engagement with the engagement hole for synchronized rotation between the toggle button and the element, and wherein the toggle button is switchable between: a transformation position where the third engaging portion disengages from the first slide groove to allow rotation of the element relative to the handle, a first fixed position where the third engaging portion engages with the first engaging portion to prevent element rotation, and a second fixed position where the third engaging portion engages with the second engaging portion to prevent element rotation.

2. The tool with adjustable configurations as claimed in claim 1, wherein the toggle button is further switchable to a third fixed position where the third engaging portion engages with the first engaging portion, preventing element rotation and maintaining the second reference axis at a 45-degree angle relative to the first reference axis.

3. The tool with adjustable configurations as claimed in claim 1, wherein the transformation mechanism further comprises a second slide seat disposed within the handle and including a second slide groove, wherein the first end of the element inserted into the handle is positioned between the first slide seat and the second slide seat, wherein the toggle button has a stabilizing portion at one end slidably inserted into the second slide groove and a pressing portion at another end protruding from the handle on a side of the first slide seat opposite from the second slide seat, and wherein the third engaging portion is positioned between the stabilizing portion and the pressing portion.

4. The tool with adjustable configurations as claimed in claim 3, wherein the transformation mechanism further comprises a spring mounted on the toggle button between the third engaging portion and the stabilizing portion, wherein a first end of the spring abuts against the second slide seat and a second end abuts against the third engaging portion, and wherein the spring biases the third engaging portion to engage with either the first engaging portion or the second engaging portion.

5. The tool with adjustable configurations as claimed in claim 1, wherein the first slide seat is formed of metal.

6. The tool with adjustable configurations as claimed in claim 3, wherein the second slide seat is formed of metal.

7. The tool with adjustable configurations as claimed in claim 3, wherein the handle includes a first handle half and a second handle half, wherein the first slide seat connects to a plurality of first fasteners and is secured to the first handle half by the plurality of first fasteners, wherein the second slide seat connects to a plurality of second fasteners and is secured to the second handle half by the plurality of second fasteners, and wherein the second handle half joins with the first handle half to position the first slide seat and second slide seat in opposition to each other.

8. The tool with adjustable configurations as claimed in claim 3, wherein the toggle button is further switchable to a fourth fixed position where the element is maintained at a 60-degree angle relative to the first reference axis.

9. The tool with adjustable configurations as claimed in claim 2, wherein the handle includes a first handle half and a second handle half, wherein the first slide seat connects to a plurality of first fasteners and is secured to the first handle half by the plurality of first fasteners, wherein the second slide seat connects to a plurality of second fasteners and is secured to the second handle half by the plurality of second fasteners, and wherein the second handle half joins with the first handle half to position the first slide seat and second slide seat in opposition to each other.

10. The tool with adjustable configurations as claimed in claim 4, wherein both the first slide seat and the second slide seat comprise metal materials.

11. The tool with adjustable configurations as claimed in claim 4, wherein the handle includes a first handle half and a second handle half, wherein the first slide seat connects to a plurality of first fasteners and is secured to the first handle half by the plurality of first fasteners, wherein the second slide seat connects to a plurality of second fasteners and is secured to the second handle half by the plurality of second fasteners, and wherein the second handle half joins with the first handle half to position the first slide seat and second slide seat in opposition to each other.

12. The tool with adjustable configurations as claimed in claim 3, wherein both the first slide seat and the second slide seat comprise metal materials.

13. The tool with adjustable configurations as claimed in claim 8, wherein the transformation mechanism further comprises a spring mounted on the toggle button between the third engaging portion and the stabilizing portion, wherein a first end of the spring abuts against the second slide seat and a second end abuts against the third engaging portion, and wherein the spring biases the third engaging portion to engage with either the first engaging portion or the second engaging portion.

14. The tool with adjustable configurations as claimed in claim 2, wherein the transformation mechanism further comprises a second slide seat disposed within the handle and including a second slide groove, wherein the first end of the element inserted into the handle is positioned between the first slide seat and the second slide seat; and wherein the toggle button has a stabilizing portion at one end slidably inserted into the second slide groove and a pressing portion at another end protruding from the handle on a side of the first slide seat opposite from the second slide seat.

15. The tool with adjustable configurations as claimed in claim 14, wherein both the first slide seat and the second slide seat comprise metal materials.

16. The tool with adjustable configurations as claimed in claim 8, wherein both the first slide seat and the second slide seat comprise metal materials, and wherein the handle includes a first handle half and a second handle half secured together with the first slide seat and second slide seat positioned in opposition to each other.

17. The tool with adjustable configurations as claimed in claim 2, wherein the toggle button is further switchable to a fourth fixed position where the element is maintained at a 60-degree angle relative to the first reference axis.

18. The tool with adjustable configurations as claimed in claim 13, wherein both the first slide seat and the second slide seat comprise metal materials.

19. The tool with adjustable configurations as claimed in claim 17, wherein the transformation mechanism further comprises a spring mounted on the toggle button between the third engaging portion and the stabilizing portion, and wherein a first end of the spring abuts against the second slide seat and a second end abuts against the third engaging portion.

20. The tool with adjustable configurations as claimed in claim 14, wherein the handle includes a first handle half and a second handle half, wherein the first slide seat and second slide seat are secured to respective handle halves by fasteners, and wherein the second handle half joins with the first handle half to position the first slide seat and second slide seat in opposition to each other.
